(19) United States
(12) Patent Application Publication
(10) Pub. No.: US 2021/0216945 A1
(43) Pub. Date: Jul. 15, 2021

(54) SYSTEM FOR PROCESSING ENTERPRISE DATA TO IMPROVE TASK PLANNING

(71) Applicant: Citrix Systems, Inc., Fort Lauderdale, FL (US)

(72) Inventors: Rohan Kapoor, Bangalore (IN); Vineet Kumar, Bangalore (IN); Sudeep Shyamal, Bangalore (IN); Vivek Joshi, Bangalore (IN); Shivani, Bangalore (IN); Jeevan Nagaraj, Bangalore (IN); Kartikay Singh, Bangalore (IN); Kumar Gaurav, Bangalore (IN); Suresh Sharma, Bangalore (IN)

(21) Appl. No.: 16/742,537

(22) Filed: Jan. 14, 2020

(51) Int. Cl. G06Q 10/06; G06K 9/62; G06Q 10/10

(52) U.S. Cl. CPC G06Q 10/063114; G06K 9/6278; G06Q 10/063118; G06Q 10/107; G06Q 10/06398

(57) ABSTRACT

A solution for provisioning a day planner system. A method is disclosed that includes processing enterprise data to identify action items having actionable tasks; processing user email data to identify priority emails and user mentioned emails; processing calendar data to identify upcoming meetings; assigning a time value to: a first task category involving action items, a second task category involving priority emails, a third task category involving user mentioned emails, and a fourth task category involving upcoming meetings; generating a user experience (UX) interface that displays: an overview showing time required to complete tasks and remaining production time for a current time period, and a thumbnail for each task category, each thumbnail having an associated time value and a number of tasks; monitoring user activities on the UX interface and, in response to the user completing a task from a task category, updating the overview and an associated thumbnail.

### BACKGROUND OF THE DISCLOSURE

In a typical work environment, most employees have primary responsibilities, e.g., a software developer is responsible for writing code, a salesperson is responsible for selling, a brand developer is responsible for creating marketing material, etc. In addition to primary responsibilities, a significant portion of an employee's day can be spent on organizational tasks such as reading and responding to emails, attending meetings, identifying deadlines, reviewing older tasks that have been postponed, etc.

### BRIEF DESCRIPTION OF THE DISCLOSURE

Aspects of this disclosure provide system that processes enterprise data to synthesize and time track organizational tasks. Solutions include a day planner application (App) that provides task planning data for the current day within a comprehensive user experience interface, thus allowing the user to more effectively review tasks, and free up more time for performing their primary responsibilities. The day planner App can be implemented as a standalone application or as part of an existing enterprise application.

A first aspect of the disclosure provides a computing system that includes a memory and a processor coupled to the memory that is configured to perform a method for facilitating task planning of a current day for a user. The system includes grouping enterprise data for a user into a set of task categories and assigning a time value to each task category, wherein each time value estimates an amount of time required to review a corresponding task category. Also included is the step of generating a user experience (UX) interface that displays: an overview showing the time value for each task category and a remaining production time for a current time period, and a thumbnail window for each task category, each thumbnail window showing an associated time value and a number of tasks. Additionally, the system includes monitoring user activities on the UX interface and, in response to the user reviewing a task from a task category, updating time values in the overview and an associated thumbnail window.

A second aspect of the disclosure provides a computerized method that includes processing user enterprise data to identify action items having actionable tasks and processing user email data to identify priority emails and user mentioned emails. Once identified, the process includes assigning a time value to each of: a first task category involving action items, a second task category involving priority emails, and a third task category involving user mentioned emails, wherein each time value estimates an amount of time required to review a corresponding task category. The method also generates a user experience (UX) interface that displays: an overview showing time values for task categories and remaining production time for the current day, and a thumbnail window for each task category that includes an associated time value and a number of tasks. The method also monitors user activities on the UX interface and, in response to the user reviewing a task from a task category, updating the overview and an associated thumbnail window.

A third aspect of the disclosure provides a computer program product stored on a computer readable storage medium, which when executed by a computing system, facilitates task planning. The program product includes program code that groups enterprise data for a user into a set of task categories and assigns a time value to each task category, wherein each time value estimates an amount of time required to review a corresponding task category. The program code also generates a user experience (UX) interface that displays: an overview showing the time value for each task category and remaining production time for a current time period, and a thumbnail window for each task category, each thumbnail window showing an associated time value and a number of tasks. Also included is program code that monitors user activities on the UX interface and, in response to the user reviewing a task from a task category, updates the time value in the overview and an associated thumbnail window.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 depicts a computing system in accordance with an illustrative embodiment.

FIG. 2 depicts an illustrative user experience interface, in accordance with an illustrative embodiment.

FIG. 3 depicts a further illustrative user experience interface, in accordance with an illustrative embodiment.

FIG. 4 depicts a further illustrative user experience interface, in accordance with an illustrative embodiment.

FIG. 5 depicts a further illustrative user experience interface, in accordance with an illustrative embodiment.

FIG. 6 depicts a further illustrative user experience interface, in accordance with an illustrative embodiment.

FIG. 7 depicts a further illustrative user experience interface, in accordance with an illustrative embodiment.

FIG. 8 depicts a flow diagram showing a method of implementing a day planner system, in accordance with an illustrative embodiment.

FIG. 9 depicts a mobile enterprise architecture, in accordance with an illustrative embodiment.

The drawings are intended to depict only typical aspects of the disclosure, and therefore should not be considered as limiting the scope of the disclosure.

### DETAILED DESCRIPTION OF THE DISCLOSURE

Embodiments of the disclosure provide technical solutions for synthesizing and managing organizational tasks (hereafter “tasks”) for a user, including the processing of enterprise data such as email and calendar data, to identify and present task-based information in a simple comprehensive visual display. The technical solutions automatically identify and categorize tasks associated with a user by employing natural language processing and machine learning. Tasks are organized and displayed within a user experience (UX) interface to efficiently review tasks based on relevance and importance.

Current electronic tools such as task lists, calendars, etc., exist to help organize task management. However, such tools lack the intelligence to analyze and display task data in a smart and comprehensive manner such that a user can easily review task in an efficient manner. Accordingly, dealing with organizational tasks remains a very manual, repetitive and cumbersome process, and is prone to errors and inefficiencies.

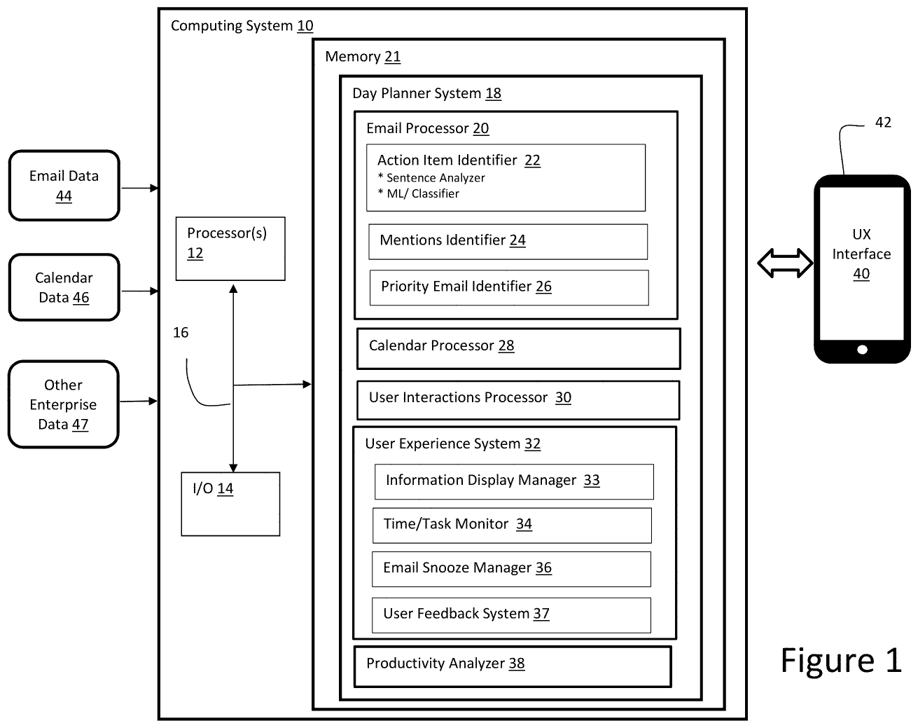

Referring to FIG. 1, an illustrative computing system 10 is shown that includes a day planner system 18 that analyzes email data 44, calendar data 46 and other enterprise data (e.g., contacts, etc.) associated with a user, and generates a user experience (UX) interface 40 for the user on a client device 42, such as a smartphone, desktop, laptop, etc. Day planner system 18 may be implemented as a standalone App or be integrated for example into an enterprise mobile platform, such as CITRIX SECURE MAIL™, which provides user management of email, calendars, contacts, etc., on mobile devices. Accordingly, some or all of the functionality of day planner system 18 may reside on the client device 42 itself and/or on a hosted system such as a cloud platform, an enterprise server, a virtual network, etc. Furthermore, while described as a “day planner,” the concepts described herein could be implemented across any timeframe, e.g., a weekend, a week, half a day, etc. Further, the planner could be adopted for multiple users, e.g., a team, a cohort, etc.

Day planner system 18 generally includes an email processor 20, a calendar processor 28, and a user interactions processor 30 that collect and categorize tasks for the user. A user experience (UX) system 32 presents the various task categories to the user to allow the user to review the tasks (i.e., review emails, attend meetings, etc.) in an organized and efficient manner. Finally, a productivity analyzer 38 is provided so the user can review their past productivity in reviewing tasks.

Email processor 20 processes email data 44 for a user to identify and categorize email-based tasks requiring attention by the user. In one illustrative embodiment, email processor 20 is configured to process unread emails, each of which represents a potential task for the user for the current day. Once an email is read, the task is generally considered reviewed. If however there is a required action associated with an email, that action will be held and displayed in an action item category until the action is reviewed (e.g., marked as done by the user). If the user wants to review an email at a later time, the user can snooze the email, which is described in further detail herein.

Email processor 20 includes an action item identifier 22 that, e.g., utilizes NLP, machine learning, etc., to review email data 44 and identify and group emails that contain action items that require some action by the user, including time sensitive and non-time sensitive actions, questions requiring or inviting a response, planning related activities, etc. Time sensitive actions items may for example include deadlines, important dates, etc., whereas non-time sensitive actions may for example include a request for information. Email processor 20 further includes a mentions identifier 24 that identifies and groups emails that directly specify the user in the subject or body of the email, and a priority email identifier 26 that identifies and groups emails flagged as high priority or the like. Although implemented as an email processor 20 that groups emails into different task categories, day planner system 18 could identify and group task-based information from any source available to an enterprise. For example, deadline information could be gathered from a planning tool that assigns tasks and deadlines to users.

Calendar processor 28 identifies upcoming meetings for the user and how long the meetings are scheduled for. User interactions processor 30 identifies recent user interactions the user had with enterprise data, such as reviewing an email attachment, editing a file, watching a video, messaging with a contact, etc.

User experience (UX) system 32 collects and synthesizes the information collected and generated by email processor 20, calendar processor 28 and user interactions processor 30. User experience (UX) system 32 includes an information display manager 33 that generates the UX interface 40 and manages user interactions therewith. In one illustrative embodiment, the UX interface 40 includes a thumbnail windows for each task category. From within each thumbnail window, the user can scroll, view, select and expand on thumbnails of tasks. UX system 32 further includes a time/task monitor 34 that tracks which tasks collected by the email processor 20 have been reviewed, which meetings have been completed and what user interactions occurred. It also calculates a time value for individual tasks/task categories, and tracks completion statuses for the different task categories. Time values may be assigned to tasks using any technique. For example, in one illustrative embodiment, time values may be assigned based on the average reading speed of an adult, e.g., 250-300 words per minute. Further, time spent by the user to read an e-mail can be recorded, and the time values for the user can thereafter be fine-tuned based on the recorded data.

UX system 32 also includes an email snooze manager 36 that allows the user to snooze emails, which are then grouped and displayed as a further “snooze” category on the UX interface 40. UX manager 32 further includes a user feedback system 37 that collects feedback such as “likes and dislikes” from the user to filter and/or enhance the user experience. Moreover, users can provide feedback relating to what is shown in each thumbnail window, and the recorded data can be used to customize the windows in the future and make sure that the most useful information is shown in the UX interface 40.

Productivity analyzer 38 provides historical statistics for the user to help maximize future productivity. For example, productivity analyzer 38 could display weekly statistics of time spent reading emails, attending meetings, etc.

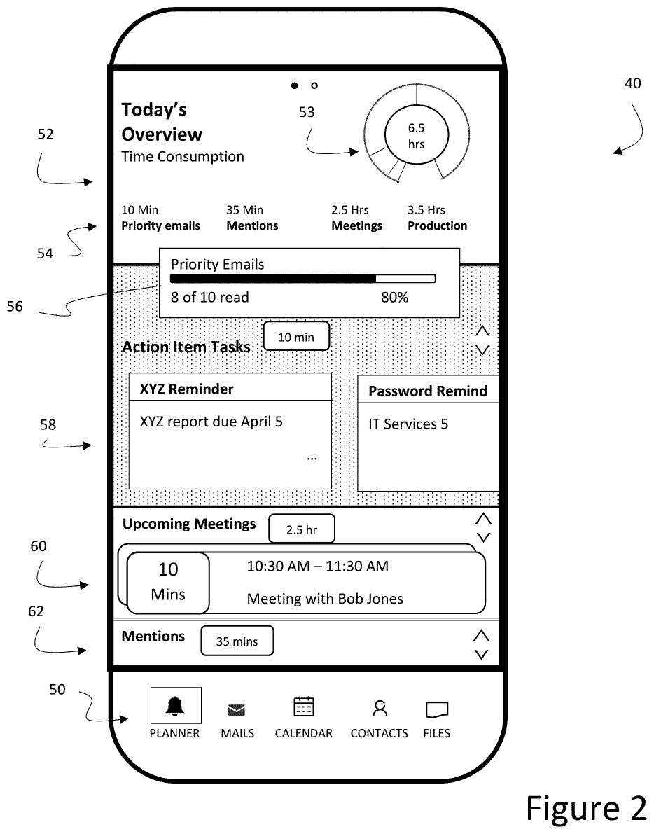

FIG. 2 depicts an illustrative UX interface 40, which can for example be displayed in response to selecting the planner icon 50 along the bottom row of enterprise functions. The UX interface 40 generally includes a set of interactive display windows that include an overview window 52 that provides a general overview of task information and a set of thumbnail windows 56, 58, 60, 62 that each depict thumbnail information for one task categories. At the top of the interface 40 is an illustrative overview window 52 (Today's Overview), which lists a set of task categories 54 and a visual tracking monitor 53. Each task category 54 includes assigned a time value, e.g., 10 minutes for Priority Emails, 35 minutes for Mentions, etc., which indicates a predicted time required to review (i.e., read emails, read action items, attend meetings, etc.) all of tasks from each category 54 for the current day. Production refers to how much time remains available in the day to perform actual work (i.e., 3.5 hours), after reviewing the identified tasks. As tasks are reviewed, the respective time value for the given task category (and production) is automatically updated. For example, once the user reads all of the priority emails, the time remaining for reviewing priority emails is 0. The visual tracking monitor 53 shows the total time predicted to complete all of the tasks for all of the displayed categories 54 and any production time remaining, in this example 6.5 hours. Different arc segments within the visual tracking monitor 53 provide a proportionate amount of time required for each category 54. (Although not shown, individual segments may be color coded for the different categories 54.) As the day progresses, the visual tacking monitor 53 is updated to reflect the current status.

Partially overlaying the overview window 52 is a priority emails window 56 that shows the status of the priority emails in the user's email account. In this example, eight of the ten priority emails for the user have been read. The user can click on the priority email window 56 to view or otherwise access those emails.

Below the priority emails window 56 is an action item tasks window 58 that include horizontally scrollable thumbnails of actionable tasks for the user (e.g., XYZ reminder, Network Password Expiration Reminder, etc.). The user can scroll through the thumbnails and click for more details. In the action items tasks window 58, the user is able to see thumbnails of all the action items determined from the user's emails (or from other enterprise data). Determining whether an email contains an actionable item may for example be achieved using NLP, machine learning and a Naive Bayes Text Classification. Alternatively, a recurrent neural network using, e.g., utilizes long short-term memory (LSTM) could likewise be used. An illustrative approach includes first training the system using a set of actionable and non-actionable sentences. For example, “The Penske report is due February 1,” could be used as an actionable sentence for training, whereas the sentence, “Joe got a new Mercedes which is in the parking lot,” would be a not actionable sentence. During training, sentences can be sanitized by removing unimportant words like prepositions, conjunctions, etc.

Once the system is trained, actual sentences from a user's email are analyzed and classified as either actionable or not actionable. For new sentences A, the sentences are sanitized to remove the unimportant words to obtain new sentences B with all words being labeled as b1, b2 . . . bn. The likelihood of B being an actionable sentence is determined according to the equation:

P(a|B)=P(a)(P(b1|a)*P(b2|a) . . . P(bn|a))

where “a” is the event of the sentence being actionable. P(a) can be derived as the normal probability based on training data and P(bₖ|a) can be taken as a measure of the contribution of the word bₖ in making any sentence actionable. This can be readily calculated using the frequency of word bₖ in the actionable sentences in the training data. The likelihood of B being non-actionable is determined from the above. The original sentence A can be classified as actionable if the probability of B being actionable is greater than it being not actionable and the probability of B being actionable is above a certain threshold (which can be empirically determined). Note that the logarithm of the actionable/not actionable likelihood values can be utilized for comparison purposes as the calculated numbers tend to be very small.

Below the deadline tasks window 58 is an upcoming meetings window 60, which may include an expandable and collapsible thumbnail list of upcoming meetings. The most immediate meeting may be displayed on top of a collapsible stack of thumbnails.

Below the upcoming meetings window 60 is a mentions window 62 (shown partially cut-off). The user can scroll down to view the full mentions window 62, e.g., using a finger swipe or keyboard control.

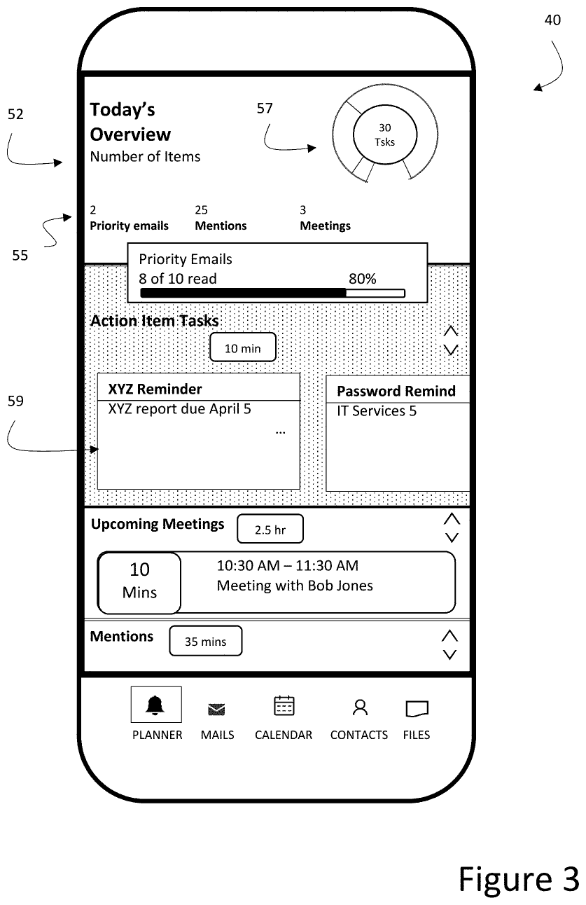

FIG. 3 depicts the UX interface 40 with an alternative overview window 52 (i.e., “Number of Items”) which can be selected by the user, e.g., by sliding right. Accordingly, rather than showing a time value for each task category 55, several tasks for individual task categories 55 are shown. In this case, a visual tracking monitor 57 shows the total number of tasks and individual arc segments show a relative amount of time to complete the tasks.

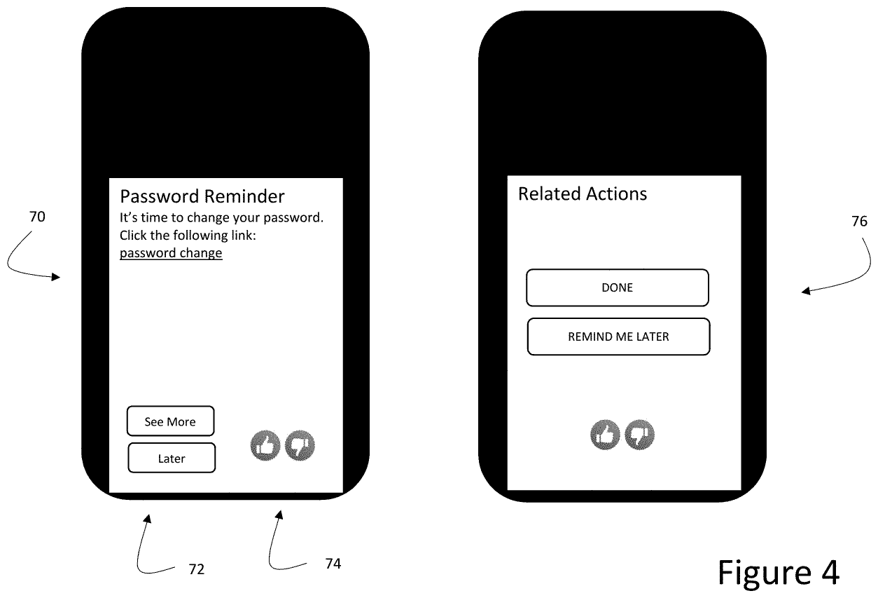

FIG. 4 depicts additional illustrative screens displayed after clicking on a deadline task thumbnail from the deadline tasks window 58 (FIG. 2). On the left image, a deadline task screen 70 is shown, which results from clicking the associated thumbnail. From within the task screen 70, the user can elect to “see more” or snooze the task by clicking “later.” The user can also provide feedback 74 by clicking thumbs up/down. If the user clicks “see more,” the original email is shown. A further illustrative screen 76 may be presented when the user clicks on “ . . . ” from within thumbnail window 59 of FIG. 3, to show a set of related actions such as “done” and “remind me later.”

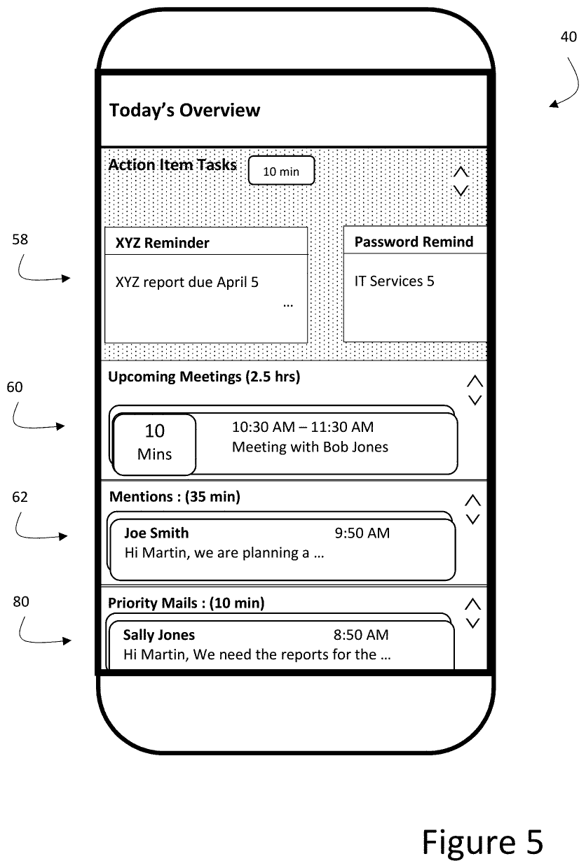

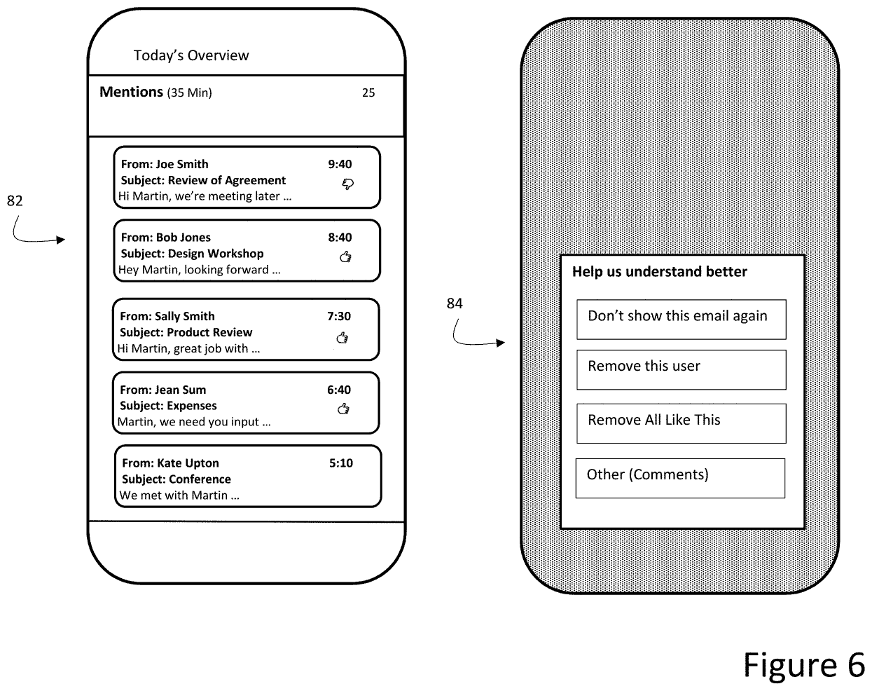

FIG. 5 depicts a further view of UX interface 40 in which the user has scrolled downward, such that the deadline tasks window 58, upcoming meetings window 60, mentions window 62, and priority mails window 80 are shown. As can be seen, meetings and emails are shown as collapsible thumbnails in the upcoming meetings window 60, mentions window 62, and priority mails window 80. By clicking on one of the windows, the respective meetings or emails are expanded. FIG. 6 shows an example of the mentions emails being expanded into a scrollable list 82. From the list, the user can select and read a particular email, or give feedback (like/dislike/comment/etc.). For example, if the user wants to provide feedback (e.g., by clicking an icon, right-clicking, etc.), a new feedback screen 84 may be displayed that allows the user to remove the email from the mentions list, remove a user from appearing in the mentions list, remove all similar emails from the mentions list, or provide comments.

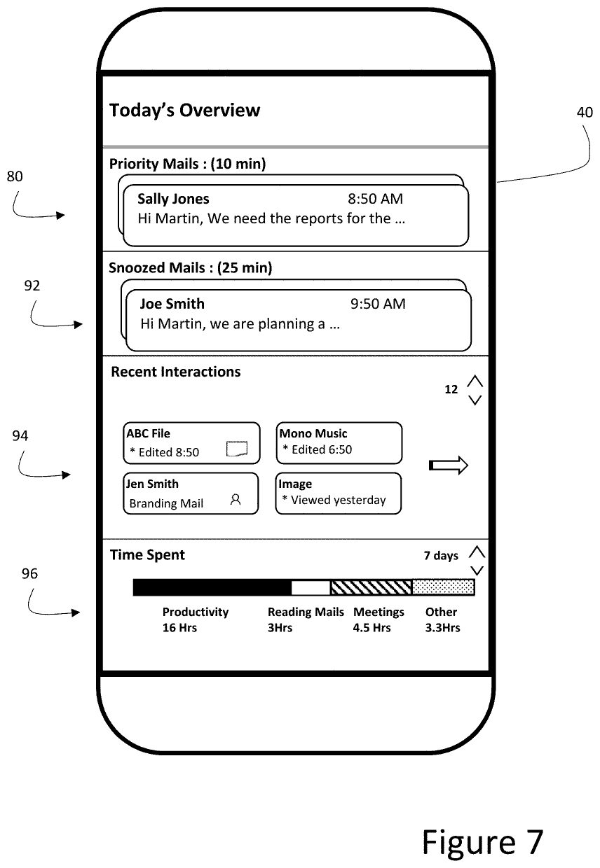

FIG. 7 depicts a further view of the UX interface 40 in which the user has scrolled further downward to show the priority mails window 80, snoozed mail window 92, recent interactions window 94, and time spent window 96. Recent interactions window 94 lists recent interactions the user has had with a particular resource. This may include editing attached files, emails with particular contacts, editing of music files, viewing image files, etc. Time spent window 96 provides past activity information for the user, including how much time is spent doing various activity (e.g., productivity, reading emails, attending meetings, etc.) over a selectable period (e.g., 7 days, 1 month, etc.).

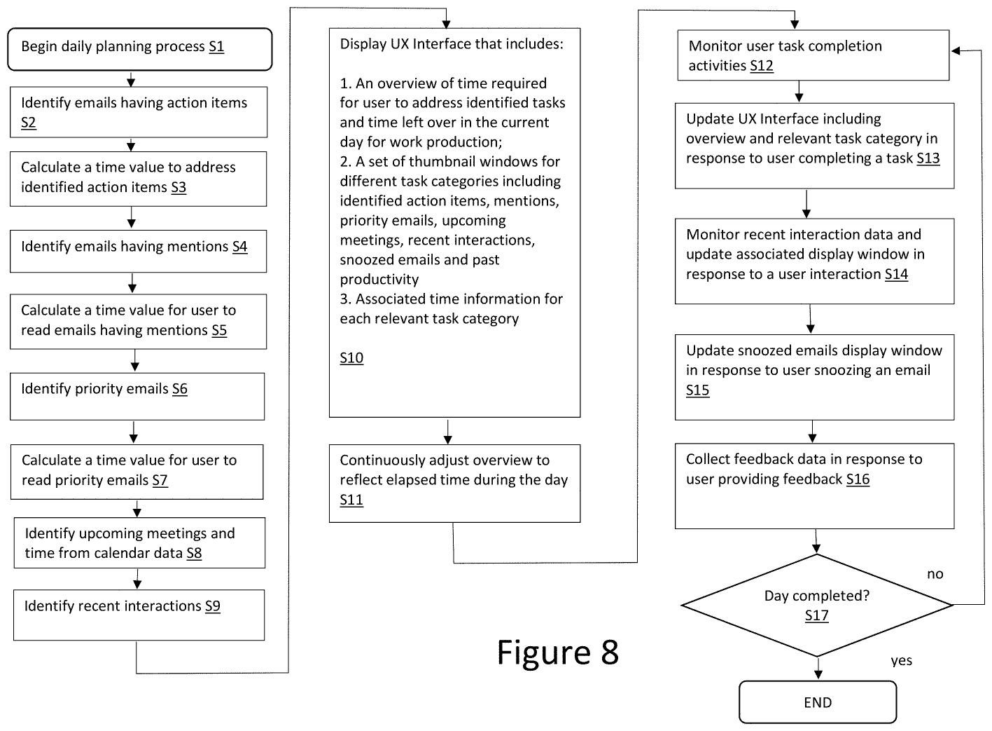

FIG. 8 depicts a flow chart showing a process of implementing day planner system 18, in which the daily planning process begins at S1, e.g., with the user launching the App and/or automatically at the beginning of each day. At S2, emails having action items (e.g., time sensitive tasks, questions, etc.) are identified and at S3, a time value is calculated and assigned for the identified action item emails. The time value represents an amount of time required for the user to read all action item emails, and may include unread emails as well as previously read emails having actions items that were not yet reviewed by the user. At S4, unread emails having mentions (i.e., the user is mentioned in the subject or body of the email) are identified and at S5, a time value is calculated and assigned for the mentions emails. At S6, unread priority emails are identified and at S7, a time value is calculated and assigned for the priority emails. At S8, upcoming meetings and their length are identified from the calendar data, and at S9, recent interactions of the user are identified.

At S10, the UX interface 40 is displayed, which generally includes: (1) An overview of time required for a user to review identified tasks and time left over in the current day for work production; (2) A set of thumbnail windows for different task categories including identified action items, mentions, priority emails, upcoming meetings, recent interactions, snoozed emails and past productivity; and (3) Associated time information for each relevant task category. At S11, the overview is continuously adjusted to reflect elapsed time during the day.

At S12, task completion activities are monitored (e.g., emails read, meetings attended, etc.) and at S13 the UX interface 40 is updated, including updating the overview and relevant task category information, in response to a task being completed by the user. At S14, recent interaction data is monitored and the associated display window is updated in response to the user having a new interaction; at S15, the snoozed emails display window is updated in response to the user snoozing an email; and at S16, feedback is collected in response to the user providing feedback. At S17, a determination is made if the day is completed, and if no the process loops back to S12 otherwise the process ends.

Note that while shown in a particular order, the steps in FIG. 8 need not be processed in the exact order shown. Some of the processing may be done in parallel or in any other order to achieve the features described herein.

Computing system 10 (FIG. 1) may for example be implemented by a cloud computing environment that employs a network of remote, hosted servers to manage, store and/or process data, and may generally be referred to, or fall under the umbrella of, a “network service.” The cloud computing environment may include a network of interconnected nodes, and provide a number of services, for example hosting deployment of customer-provided software, hosting deployment of provider-supported software, and/or providing infrastructure. In general, cloud computing environments are typically owned and operated by a third-party organization providing cloud services (e.g., Amazon Web Services, Microsoft Azure, etc.), while on-premises computing environments are typically owned and operated by the organization that is using the computing environment. Cloud computing environments may have a variety of deployment types. For example, a cloud computing environment may be a public cloud where the cloud infrastructure is made available to the general public or particular sub-group. Alternatively, a cloud computing environment may be a private cloud where the cloud infrastructure is operated solely for a single customer or organization or for a limited community of organizations having shared concerns (e.g., security and/or compliance limitations, policy, and/or mission). A cloud computing environment may also be implemented as a combination of two or more cloud environments, at least one being a private cloud environment and at least one being a public cloud environment. Further, the various cloud computing environment deployment types may be combined with one or more on-premises computing environments in a hybrid configuration.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

As will be appreciated by one of skill in the art upon reading the following disclosure, various aspects described herein may be embodied as a system, a device, a method or a computer program product (e.g., a non-transitory computer-readable medium having computer executable instruction for performing the noted operations or steps). Accordingly, those aspects may take the form of an entirely hardware embodiment, an entirely software embodiment, or an embodiment combining software and hardware aspects. Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof.

Computing system 10 (FIG. 1) may comprise any type of computing device that for example includes at least one processor 12, memory 21, an input/output (I/O) 14, e.g., one or more I/O interfaces and/or devices, and a communications pathway or bus 16. In general, the processor(s) execute program code which is at least partially fixed in memory. While executing program code, the processor(s) can process data, which can result in reading and/or writing transformed data from/to memory and/or I/O for further processing. The pathway provides a communications link between each of the components in the computing device. I/O can comprise one or more human I/O devices, which enable a user to interact with the computing device and the computing device may also be implemented in a distributed manner such that different components reside in different physical locations.

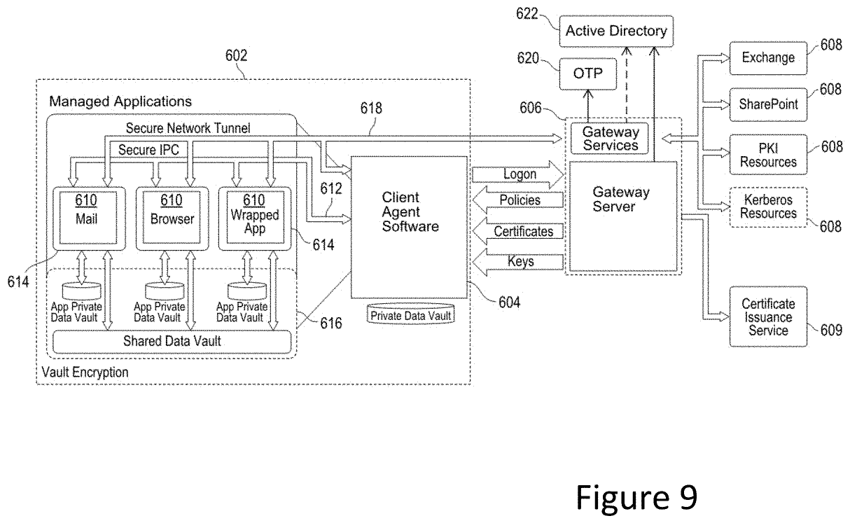

FIG. 9 depicts an illustrative enterprise mobility management system 600 suitable for deploying the day planner system (FIG. 1). In this case, the left hand side represents an enrolled mobile device 602 with a client agent 604, which interacts with gateway server 606 (which includes Access Gateway and application controller functionality) to access various enterprise resources 608 and services 609 such as Exchange, Sharepoint, public-key infrastructure (PKI) Resources, Kerberos Resources, Certificate Issuance service, as shown on the right hand side above. Although not specifically shown, the mobile device 602 may also interact with an enterprise application store (StoreFront) for the selection and downloading of applications.

The client agent 604 acts as the UI (user interface) intermediary for Windows apps/desktops hosted in an Enterprise data center, which are accessed using the High-Definition User Experience (HDX)/ICA display remoting protocol. The client agent 604 also supports the installation and management of native applications on the mobile device 602, such as native iOS or Android applications. For example, the managed applications 610 (mail, browser, wrapped application) shown in the figure above are all native applications that execute locally on the mobile device 602. Client agent 604 and application management framework of this architecture act to provide policy driven management capabilities and features such as connectivity and SSO (single sign on) to enterprise resources/services 608. The client agent 604 handles primary user authentication to the enterprise, normally to Access Gateway (AG) 606 with SSO to other gateway server components. The client agent 604 obtains policies from gateway server 606 to control the behavior of the managed applications 610 on the mobile device 602.

The Secure InterProcess Communication (IPC) links 612 between the native applications 610 and client agent 604 represent a management channel, which may allow a client agent to supply policies to be enforced by the application management framework 614 “wrapping” each application. The IPC channel 612 may also allow client agent 604 to supply credential and authentication information that enables connectivity and SSO to enterprise resources 608. Finally, the IPC channel 612 may allow the application management framework 614 to invoke user interface functions implemented by client agent 604, such as online and offline authentication.

Communications between the client agent 604 and gateway server 606 are essentially an extension of the management channel from the application management framework 614 wrapping each native managed application 610. The application management framework 614 may request policy information from client agent 604, which in turn may request it from gateway server 606. The application management framework 614 may request authentication, and client agent 604 may log into the gateway services part of gateway server 606 (for example, Citrix Gateway). Client agent 604 may also call supporting services on gateway server 606, which may produce input material to derive encryption keys for the local data vaults 616, or may provide client certificates which may enable direct authentication to PKI protected resources, as more fully explained below.

In more detail, the application management framework 614 “wraps” each managed application 610. This may be incorporated via an explicit build step, or via a post-build processing step. The application management framework 614 may “pair” with client agent 604 on first launch of an application 610 to initialize the Secure IPC channel 612 and obtain the policy for that application. The application management framework 614 may enforce relevant portions of the policy that apply locally, such as the client agent login dependencies and some of the containment policies that restrict how local OS services may be used, or how they may interact with the managed application 610.

The application management framework 614 may use services provided by client agent 604 over the Secure IPC channel 612 to facilitate authentication and internal network access. Key management for the private and shared data vaults 616 (containers) may be also managed by appropriate interactions between the managed applications 610 and client agent 604. Vaults 616 may be available only after online authentication, or may be made available after offline authentication if allowed by policy. First use of vaults 616 may require online authentication, and offline access may be limited to at most the policy refresh period before online authentication is again required.

Network access to internal resources may occur directly from individual managed applications 610 through Access Gateway 606. The application management framework 614 may be responsible for orchestrating the network access on behalf of each managed application 610. Client agent 604 may facilitate these network connections by providing suitable time limited secondary credentials obtained following online authentication. Multiple modes of network connection may be used, such as reverse web proxy connections and end-to-end VPN-style tunnels 618.

The Mail and Browser managed applications 610 have special status and may make use of facilities that might not be generally available to arbitrary wrapped applications. For example, the Mail application 610 may use a special background network access mechanism that allows it to access an Exchange server 608 over an extended period of time without requiring a full AG logon. The Browser application 610 may use multiple private data vaults 616 to segregate different kinds of data.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A computing system, comprising:
a memory; and
a processor coupled to the memory and configured to perform a method for facilitating task planning of a current day for a user, the method including:
grouping enterprise data for a user into a set of task categories;
assigning a time value to each task category, wherein each time value estimates an amount of time required to review a corresponding task category;
generating a user experience (UX) interface that displays:
an overview showing the time value for each task category and a remaining production time for a current time period, and
a thumbnail window for each task category, each thumbnail window showing an associated time value and a number of tasks; and
monitoring user activities on the UX interface and, in response to the user reviewing a task from a task category, updating time values in the overview and an associated thumbnail window.

2. The system of claim 1, wherein the enterprise data includes email data and calendar data.

3. The system of claim 2, wherein the set of task categories include: a first task category involving action items, a second task category involving priority emails, a third task category involving user mentioned emails, and a fourth task category involving upcoming meetings.

4. The computing system of claim 3, wherein action items are identified using a naïve Bayes text classification to classify email sentences as actionable or not actionable.

5. The computing system of claim 3, wherein user mentioned emails specify the user in a subject or body of the email.

6. The computing system of claim 1, wherein at least one thumbnail window is expandable to view a complete list of tasks for an associated task category.

7. The computing system of claim 1, wherein the UX interface includes:
a feature to snooze emails and includes a window for displaying snoozed emails.
a window for displaying recent user interactions.

8. The computing system of claim 1, wherein the UX interface further displays a productivity window that details time spent during a past time period on different task categories.

9. A computerized method, comprising:
processing user enterprise data to identify action items having actionable tasks;
processing user email data to identify priority emails and user mentioned emails;
assigning a time value to each of: a first task category involving action items, a second task category involving priority emails, and a third task category involving user mentioned emails, wherein each time value estimates an amount of time required to review a corresponding task category;
generating a user experience (UX) interface that displays:
an overview showing time values for task categories and remaining production time for the current day, and
a thumbnail window for each task category that includes an associated time value and a number of tasks;
monitoring user activities on the UX interface and, in response to the user reviewing a task from a task category, updating the overview and an associated thumbnail window.

10. The method of claim 9, further including: processing calendar data to identify upcoming meetings for the current day, assigning a time to a fourth task category involving calendar data, and including the time value in the overview.

11. The method of claim 9, wherein action items are identified using a naïve Bayes text classification to classify email sentences as actionable or not actionable.

12. The method of claim 9, wherein user mentioned emails specify the user in a subject or body of the email.

13. The method of claim 9, wherein each thumbnail window is expandable to view a complete list of tasks for an associated task category.

14. The method of claim 9, wherein the UX interface include a feature to snooze emails and includes a window for displaying snoozed emails.

15. The method of claim 9, wherein the UX interface further includes a window for displaying recent user interactions.

16. The method of claim 9, wherein the UX interface further displays a productivity window that details time spent during a past time period on different task categories.

17. A computer program product stored on a computer readable storage medium, which when executed by a computing system, facilitates task planning, wherein the computer program product comprises:
program code that groups enterprise data for a user into a set of task categories;
program code that assigns a time value to each task category, wherein each time value estimates an amount of time required to review a corresponding task category;
program code that generates a user experience (UX) interface that displays:
an overview showing the time value for each task category and remaining production time for a current time period, and
a thumbnail window for each task category, each thumbnail window showing an associated time value and a number of tasks; and
program code that monitors user activities on the UX interface and, in response to the user reviewing a task from a task category, updates the time value in the overview and an associated thumbnail window.

18. The program product of claim 17, wherein the set of task categories include: a first task category involving action items, a second task category involving priority emails, a third task category involving user mentioned emails, and a fourth task category involving upcoming meetings.

19. The program product of claim 15, wherein action items are identified using a naïve Bayes text classification to classify email sentences as actionable or not actionable.

20. The program product of claim 15, wherein:
user mentioned emails specify the user in a subject or body of the email;
each thumbnail window is expandable to view a complete list of tasks for an associated task category;
the UX interface allows includes a feature to snooze emails and includes a thumbnail window for displaying snoozed emails; and
the UX interface further includes a window for displaying recent user interactions and a productivity window that details time spent during a past time period on different task categories.
